(19) United States
(12) Patent Application Publication
(10) Pub. No.: US 2016/0145934 A1
(43) Pub. Date: May 26, 2016

(54) Protective Additional Glazing Systems, Apparatus, and Methods For Structural Openings

(71) Applicant: GARY TROTT, NAPEAN (CA)

(72) Inventor: GARY TROTT, NAPEAN (CA)

(73) Assignee: IMPACT SECURITY LLC, PALM HARBOR, FL (US)

(21) Appl. No.: 14/934,125

(22) Filed: Nov. 5, 2015

Related U.S. Application Data
(60) Provisional application No. 62/075,287, filed on Nov. 5, 2014.

(51) Int. Cl. E06B 5/11; E06B 9/00; E06B 3/26

(52) U.S. Cl. CPC E06B 5/11; E06B 3/26; E06B 9/00

(57) ABSTRACT

A protective additional glazing system, apparatus, and associated methods is disclosed for the protection of structural openings against impacts from projectiles from any cause, including nature or man. The system consists of a substantially rigid panel, substantially the same size as the visible glass being protected, that may be attached to the inside of the frame mounting the original glass via a standoff/anchor that is attached to the original frame via an adhesive means. Another embodiment consists of a substantially rigid panel cut slightly larger than the visible original glazing being protected, said panel being attached to the structural opening via a standoff/anchor/adhesive means. This invention provides security and protection in an effective and affordable manner.

### FIELD OF THE INVENTION

The glazing of windows and doors with clear rigid panels and the use of window films for safety and security are used in many different industries and has a very significant presence within the building industry and for some vehicles (busses for example). In nearly all of these instances they are framed in a manner similar to that typically found in common building practice. This is true even for ballistic protection, where the panel may be placed as double glazing in front of original glass, once again in typical and separate framing supports.

### DESCRIPTION OF THE RELATED ART

In an increasing violent society, businesses, educational institutions, and homes are subject to an increased number of threats against life, liberty and property. These threats can include ballistic threats, threats of explosive blasts, forced entry threats, and others. Businesses and homes in areas of high crime are increasingly forced to employ security measures to protect against these threats. These security measures can include the installation of glazing with increased strength. For example, bullet resistant glazing or glazing that can resist various impacts and attempts at intrusion are finding their way onto both residential and industrial buildings. Additionally, window films are marked with security claims that they protect against intrusion and projectiles from would-be perpetrators.

Buildings in areas that are subject to natural disasters, such as hurricanes, tornadoes and other severe storms, require weatherproofing and additional protection from the elements. With climate change concerns, families, businesses, and governments seek effective yet low-cost means to protect structures and lives.

Several products are available to protect inhabitants of buildings from intrusion by unwanted humans or wind-born debris: new windows/doors with stronger glass, additional panels with mechanical attachments, and window films. Unfortunately, each has many negative attributes, one being cost for those alternatives that are truly effective against intrusion.

For example, conventional security improvement schemes require that the existing window and frame be removed and replaced with a new, stronger glazing and framing system. Because the old windows and frames need to be removed first before the new windows and frames can be installed, the costs of such jobs are greatly increased. Moreover, lead times to supply the frames and glazing and the area downtime, that is, the time required for workmen to come in, tear down the existing structure, and install the new structure, is also substantial. Furthermore, there is a risk of contamination to the work-area resulting from the demolition and reconstruction of the frame and surrounding building structure. This of course affects the occupants who need the building for their daily living or business needs.

Another disadvantage of conventional schemes is that the noise, commotion and disruption inherent in tearing out the old frame and existing building materials, in addition to the significant down-time, precludes a discreet security enhancement. Because of the conspicuous nature of conventional schemes, they may unnecessarily cause fear in the workplace or unwittingly reveal to third parties the additional security measures.

Conventional retrofit methods for increasing the security of a building are usually not aesthetically pleasing and leave unsightly anchoring, such as screws or other evidence of sizing the frame (e.g., cut marks, edges, and scratches).

Once the typical new window glazing is in place, conventional frames do not allow for upgrades to glazing with a greater thickness. In order to upgrade with conventional frames, the entire frame must be removed and a suitable frame having dimensions to accommodate the glazing having a greater thickness must be installed.

In many cases impact glass and window films are used to add security. However, with both of these solutions, under impact, the underlying glass is broken sufficiently to allow intruders to breech the protection, and the impact glass must be replaced adding cost, and disruption. The key to intrusion protection is keeping the intruder out for sufficient time to allow police to arrive. Window films and to a lesser degree impact glass cannot keep the intruder out. This is a key element that is not delivered by these methods. Given that the glass normally breaks with these methods, the entire glass and surrounding structure must be replaced. This a costly consequence of defeated glazing systems. More costly is that once the intruder is in, lives may be at stake.

Another disadvantage is that conventional frames and methods to install them are costly, time-consuming with long lead times, and require two or more workers to aid in positioning the glass or glazing in the frames, and the normal operations of the building occupants is compromised especially if the weather or climate is inclement, requiring the addition of plastic sheeting etc., to protect the interior.

Accordingly, there remains a need in the industry for an improved window and/or door protection system to fit the need that overcomes the advantages set forth previously.

### SUMMARY OF THE INVENTION

It is one object of the present invention to provide an improved system for supporting and holding a secondary security glazing panel without the need to remove or replace an existing glazing and existing frame.

It is another object of the present invention to provide an improved and robust attachment system that adjusts to glazing of different thicknesses, lengths, and widths. It is another object of the present invention to provide an improved installation process that does not disturb the interior environment by retaining the original glazing such that the previous envelope is never disturbed or penetrated.

It is another object of the present invention to provide a security solution that is virtually un-noticeable, aesthetically pleasing, and which does not use any screws requiring drilling into the existing framework which may compromise the warranty of the existing glazing.

It is also an object of the present invention to provide an improved installation that is cost-effective and a method of installing that is suitable for one-person to handle that reduces the amount of time, cost, and effort involved in installation.

### BRIEF DESCRIPTION OF THE DRAWINGS

FIG. 1A is a front elevation view of the invention covering a window frame.

FIG. 1B is a front elevation view showing how and where the panel is attached.

FIG. 1C is a top cross-sectional view highlighting two different standoff/anchor means.

FIG. 2A is a front elevation view of the invention covering a window on a door with minimal standoff distance supplied by the supporting frame.

FIG. 2B is a cross-sectional view from the side of the structure and invention in 2A.

FIG. 3A is a front elevation view of a means to standoff and retain a panel with fluting that permits air to enter behind the panel.

FIG. 3B is a cross-sectional view of the panels and attachment system from 3A.

FIG. 3C is a front elevation view of the placement of components from 3A and 3B.

FIG. 4A is a cross-sectional exploded view of a system in which a standoff distance may be increased beyond protective panel thickness.

FIG. 4B is a cross-sectional view of the system in 4A.

### DETAILED DESCRIPTION OF THE INVENTION

Referring to the figures, exemplary embodiments of the invention will now be described. The exemplary embodiments are provided to illustrate aspects of the invention and should not be construed as limiting the scope of the invention. The exemplary embodiments are primarily described with reference to the figures.

For purposes of this description the following definitions are being adopted. “Inside of Frame” means surface of the frame that is substantially perpendicular to both the protective panel and the glazing pane being protected.

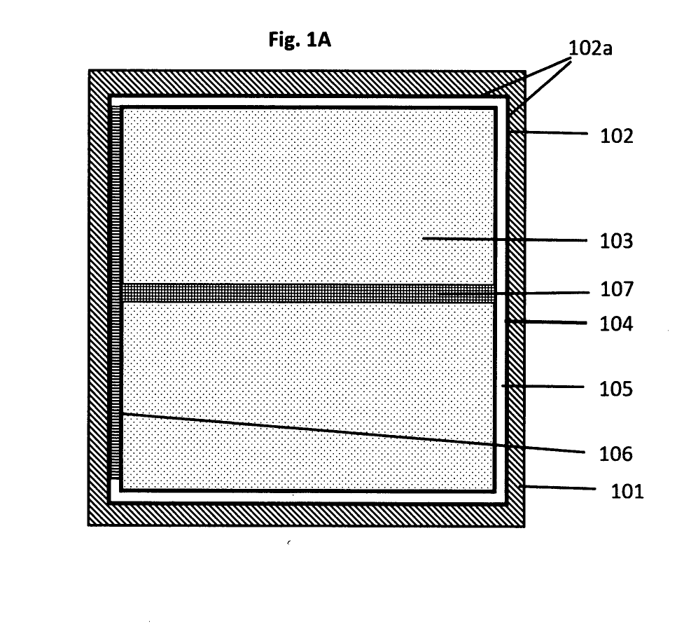

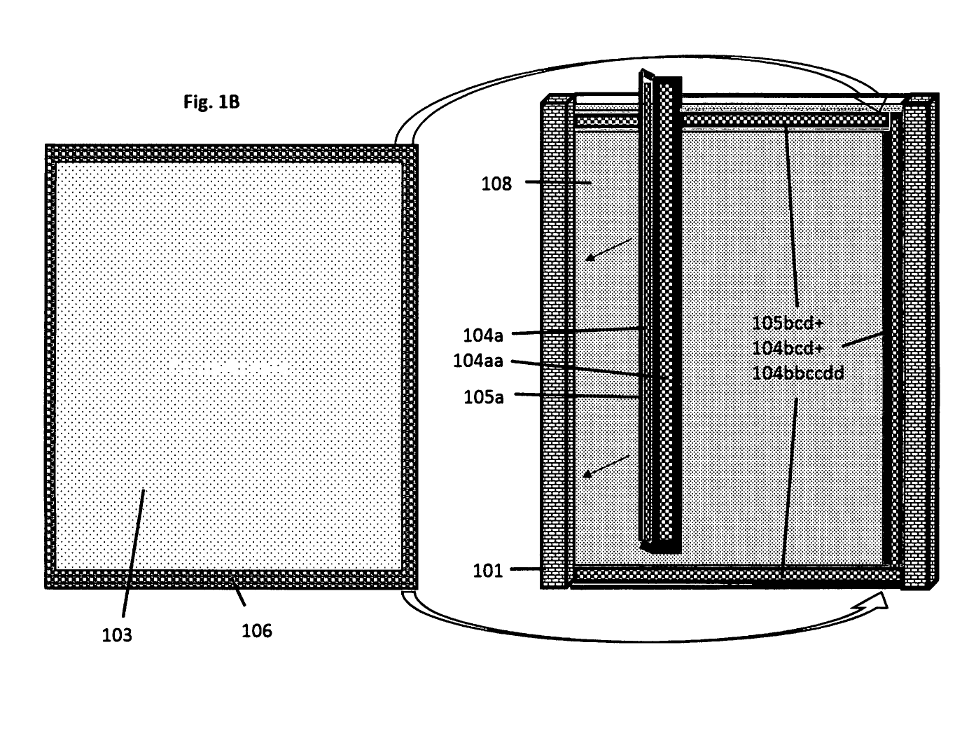

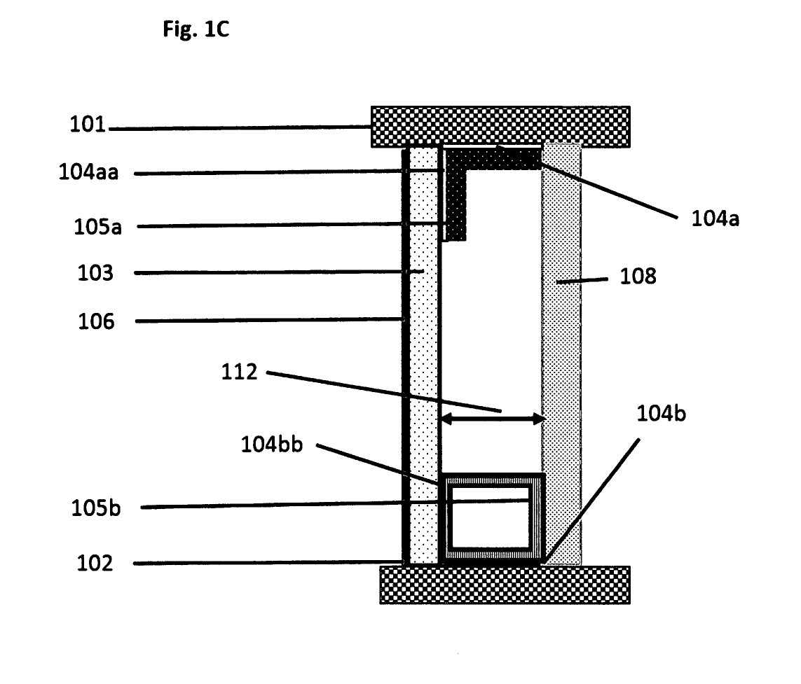

FIG. 1A illustrates an elevation front view of a structure window frame 101 as might be found on typical store fronts, hospitals or schools, or commercial or residential buildings, in which the original glass is recessed within the frame 108 (not shown in FIG. 1A). The external perimeter of the face of panel 103 is bonded to standoff/anchor means 105 that is bonded to opening frame 101 using adhesive means 104. By way of example, as a method of installation, (1) standoff/anchor means 105 may be bonded to the inside of the frame 101 (substantially perpendicular to panel and glass panes) via adhesive means 104 and (2) panel 103 is then mounted to standoff/anchor means 105 via adhesive means 104. A sealant 102 may be applied at lines 102a for the purpose of preventing humidity, vermin, or other air-borne debris from entering behind the panel 103.

In some embodiments, panel 103 is typically shaped to the same dimensions of the visible underlying glazing being protected including, but not limited to, trapezoidal, circular, rectangular or oddly shaped openings. It may be clear or opaque, wood, metal, or plastic. In the preferred embodiment, a polycarbonate plastic may be used that permits light to pass yet is extremely strong against forces of nature or man. Panel 103 may be selected from, but is not limited to, Bayer Makrolon GP polycarbonate sheet material. Various other polycarbonate sheet materials may be used depending on the application, even up to ballistic grade. One potential panel material is Bayer Makrolon polycarbonate sheet, having a polished surface, is optically clear, can be UV stabilized, and is a transparent sheet product. It features outstanding impact strength, light weight, superior dimensional stability, high temperature resistance, and high clarity. Other polycarbonate sheet products can also be used offering a variety of physical properties useful for the intent of this invention. The thickness of the polycarbonate sheet products may range between 0.210″ and 0.500″.

If the application is storm-related (e.g., for hurricane or typhoon), a triple wall, extremely light weight polycarbonate sheet may be used that could if wanted, permit air to enter the structure and is described in more detail below.

Standoff/anchor means 105 may be selected from a range of materials including wood, metal, and plastic, however, in the preferred embodiment, aluminum may be chosen for its strength to weight ratio. The shape of standoff/anchor means 105 may take different forms. In two different preferred embodiments, right angle aluminum or box channel may be used as shown in FIG. 1D. Standoff/anchor means 105 may have dimensions creating a standoff distance between the panel 103 and original glazing 108 of between 0.250″ to 1.500″. Standoff/anchor means 105 may have perpendicular cross-sectional dimensions (parallel to panel 103) of 0.500″ to 1.500″.

Adhesive means 104 may be selected from a range of products. VHB tapes (“Very High Bond” tapes) may be optimal for multiple reasons including a) the bonding agent used strongly grips relevant metals, glass, and plastics and b) the foam between the bonding agent on each side serves as both a cushion and provides additional standoff distance that may protect the original window glass from impact. Lab-tested and proven under real conditions, VHB tape eliminates rivets, bolts, screws and welds, and the need to drill holes and to use screws, etc., that would mar the normally clean installation of the existing framework and likely void the window warranty. It forms strong bonds with polycarbonate, vinyl, plastics and both painted and unpainted metals. “VHB” is intended herein to be a generic term being sourceable from any manufacturer, e.g., 3M, Essentra, etc.

In some embodiments, to prevent liquid, vermin, and other air-borne debris intrusion, a clear sealant 102 may be applied around panel 103 and opening frame 101. This sealant should be compatible with the panel 103 and form a strong bond with it and all frame materials. It may be beneficial for the sealant to be able to expand and contract with the panels in heat, cold, direct sunlight, shade, etc.

In most embodiments, edge banding 106 may be used to camouflage the view beneath. This camouflage feature is very important because it hides from view the standoff/anchor means 105 and the adhesive means 104; this feature helps good inhabitants not feel like they are incarcerated and fools crime perpetrators into not realizing the protection is in place making it more difficult to detect and overcome the system. Edge banding 106 may, for example, comprise a PVC tape with adhesive on one side; the other side may be color-matched to the frame for colors and textures including metallic views. Edge banding tape does not contribute to structural integrity. It is of particular importance for buildings that need to maintain their “curb appeal” (such as stores), and for educational institutions that desire a secure environment that does not appear to be fortress-like. The width of the edge banding 106 may be of a dimension to substantially hide the components beneath it.

In other embodiments, a reinforcing mullion 107 may be added if the opening is of sufficient size that the panel 103 might deflect and impact the original glass. Such mullions are common in the industry, may be constructed from aluminium and other materials, and may be affixed to the original frame behind panel 103 via adhesive means or traditional hardware. Depending upon the size of the glazing being protected, a cushion made of spongy material may be located between the mullion and the original glazing to prevent or mitigate abrupt movement of the mullion into the glass. In an alternative embodiment, instead of a mullion, a cushion of variable height could be adhered to either the panel 103 or the original pane 108 in approximately the center of the panels to cushion any potential impact between the pane and the panel.

FIG. 1B illustrates a front-elevation exploded view. Original glazing 108 mounts in existing frame 101. On each of the two outside faces of angle standoff/anchor means 105a, one or more strips of double-sided adhesive means 104a (perpendicular to panel 103) and 104aa (parallel to panel 103) is affixed. The outside face of standoff/anchor means 105 (perpendicular to panel 103) is affixed to the inside of frame 101 via adhesive means 104a. Standoff/anchors 105abcd are in place attached via adhesive means 104abcd. Finally, panel 103 is attached to standoff/anchor means 105abcd via adhesive means 104aabbccdd, etc. Edge-banding 106 beneficially camouflages anchor means beneath panel 103. One may alternatively install adhesive means 104aabbccdd first on the perimeter of panel 103 and place the panel and adhesive means on 105abcd.

FIG. 1C illustrates a top cross-sectional view of the various elements, including different means for maintaining stand-off distance via standoff/anchor 105a&b. Angle profile 105a and box channel profile 105b are shown and may be used. Panel 103 may be installed in frame 101 via the following: Angle 105a or box channel 105b is attached to the perpendicular wall of frame 101 via adhesive means 104a and 104b respectively; panel 103 is then bonded to standoff/anchor means 105a or 105b via adhesive means 104aa and 104bb; and edge-banding 106 may then properly cut and applied around the perimeter of panel 103 over any visible standoff/anchor means. Sealant 102 may be applied around the edges of panel 103 at or over its junction with panel 101 to add additional bonding between the frame and panel and to seal out weather and vermin. In this manner, original glazing 108 is protected.

Important to the protection of the original glass pane 108 is the standoff distance 112 between original glass panel 108 and panel 103. It is preferred that the deflected panel 103 not come in contact with original pane 108. It is also preferred for sufficient bonding surface to be available on frame 101 for adhesive means 104 to adhere for maximum bonding strength. Standoff distance 112 is dependent on the size of the opening being protected with large panes requiring more standoff distance to absorb impacts before recoiling to the pre-impact conformation. In the preferred embodiment, 1 inch may be generally specified.

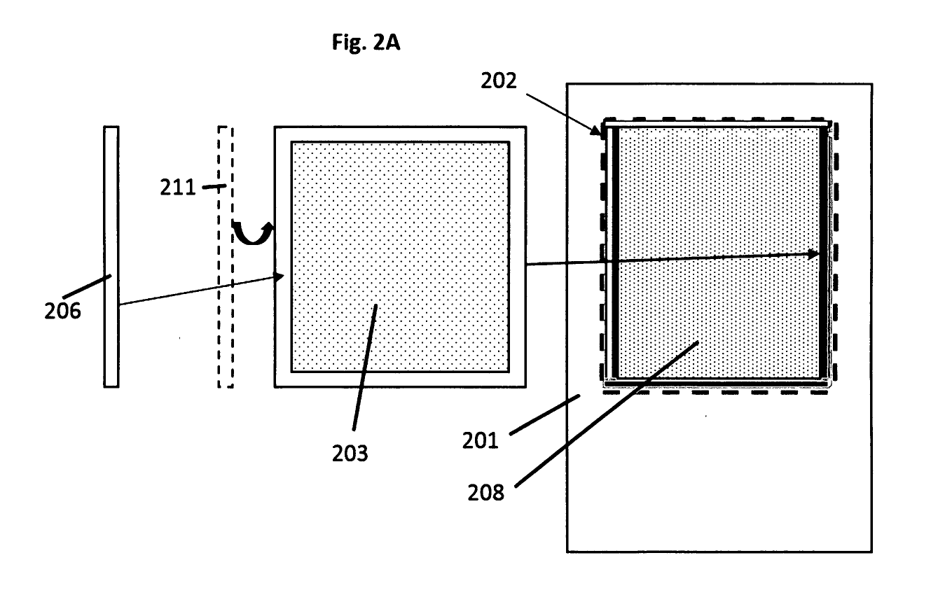

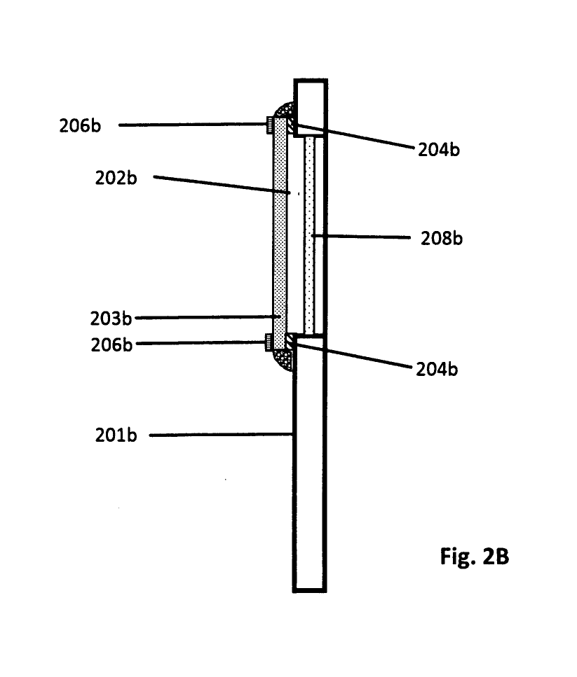

FIG. 2A illustrates an “on-frame” embodiment that may be bonded on the outside of any frame containing a glazing, e.g., a door containing a glazing or a window containing a glazing. This embodiment may be preferable for openings in which there is a minimal standoff distance (in this case a door), meaning the distance from the outside of glass pane 208 to the exterior of the door skin 201 is minimal such that there or would be insufficient stand-off distance to permit panel flexing that upon impact may contact and break glass pane 208 or insufficient perpendicular frame wall surface on which to bond a standoff/anchormeans. Adhesive/standoff means 211 may be applied to the perimeter of the inside face of panel 203. This assembly is then bonded to the outer skin of the opening framing 201. Panel 203 would be cut with final dimensions slightly larger than the original visible glazing 208 being protected with at least 0.750 inches being recommended. Once panel 203 is secured, sealant 202 may be added around the perimeter between panel 203 and framing 201 to add additional strength and to prevent moisture, gasses, and vermin from entering behind the panel. Edge banding 206 may be applied to camouflage the protective elements for reasons already explained. The previous discussion provides an example of how to assemble the components (and their order) and is not intended to limit the multiple paths that could be used to assemble the system.

It is important to note that additional standoff via adhesive/standoff means 211 is achieved because different adhesive tapes have core/substrates that may come in varying depths, thus additional standoff can be achieved with thicker foam core/substrates. In an alternative embodiments, plastic, metal or wood strips of rectangular cross section can be added as a standoff with additional strips of double sided adhesive around the same perimeter.

FIG. 2B illustrates a cross-sectional side view of an opening which in this case is a door. Original glazing 208b set in frame 201b is being protected by the invention.

Adhesive means 204b bonds the panel 203b to the door skin 201b. Edge banding 206b may be applied to hide components below it and may match the color of the opening. Sealant 202b may be applied around the polycarbonate sheet 203b.

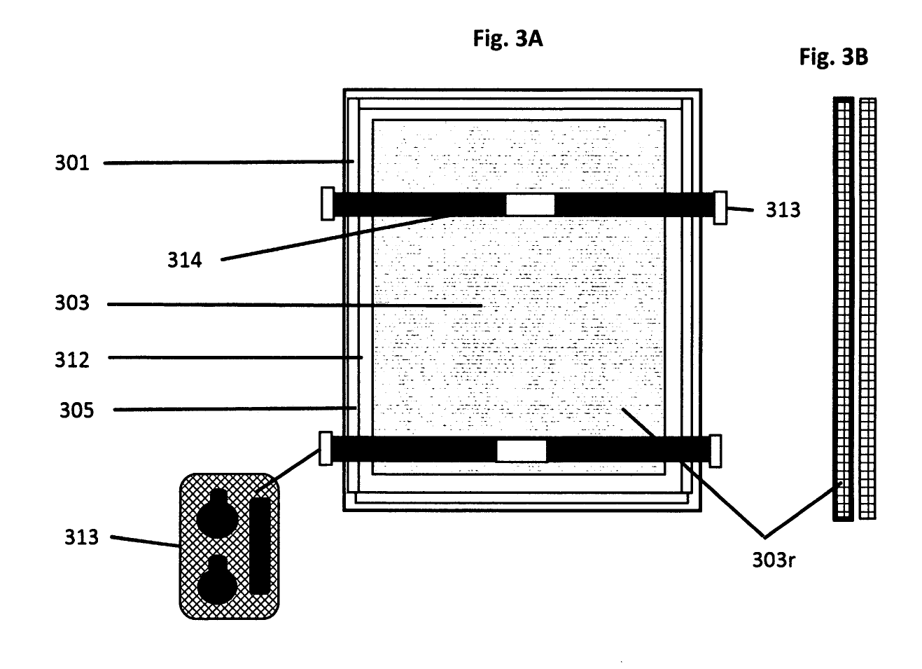

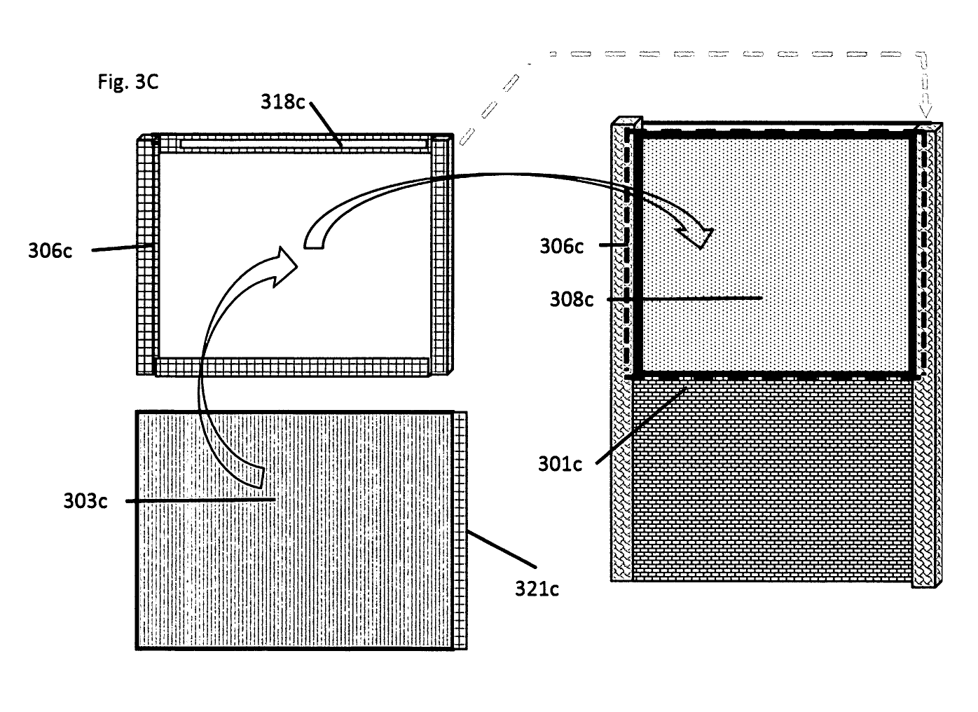

FIGS. 3A&B&C illustrates another embodiment of the invention useful in hot and hurricane prone environments in which users wish to have impact protection and air ventilation prior to, during, and immediately after a storm. This embodiment may use a multiwall (ribbed) version panel 303 which is significantly lighter than solid polycarbonate or plywood paneling. FIG. 3A is a front view of the panel system while FIG. 3B is a side view of the panel material. The multi-wall ribs 303r in the panel allow air to pass through it. This feature of the multi-wall panels may be used in creating the standoff/anchor means 306 that is used to anchor the panel to the opening while permitting air to pass behind the panel. This air flow creates ventilation for the opening and structure. In this embodiment, the panel 303 is applied as an on-frame installation with a standoff/anchor means created by utilizing fluted panel material 306 cut into strips between 0.500 and 2.000 inches wide and affixed between the entire panel's internal perimeter and the face of the frame and/or wall of the building. As this embodiment is intended to be employed as a temporary device to protect against hurricane debris and winds in lower wind zones (one and two), interlocking removable tape systems like DualLock™ and/or Velcro® tape 305 attachment means may be used to allow removal and reapplication.

For higher wind zones, another embodiment of the invention may use cargo type belts 314 as an additional anchoring means to affix panel 303 to the structure of the building. Strap brackets 313 in to which cargo type belts 314 thread, may be removable. In this embodiment, these plate metal brackets may have “keyhole” openings to allow easy installation and removal. Hurricane rated anchors with exposed heads may be used in the bracket slots, and bolted to the structure with approved hurricane anchors. The panel may be bonded to the building frame via attachment means 305 which may be “VHB snap back tape”. This Velcro type system uses “mushroom” shaped caps which interlock creating a secure form of attachment which is easily applied with pressure until a “snap” is heard, confirming that the panel is securely attached to the building. The panel can be applied and removed hundreds of times. One side of the two piece tape system may remain permanently on the building while its mate may be permanently attached to the panel.

FIG. 3C illustrates the method and placement of the various components to protect original pane 308c. Opening 301c may be thoroughly cleaned with various cleaning solvents where it will contact the adhesives. Standoff/anchor means 306c is prepared by cutting strips from panel 303c and matching the needed perimeter dimensions of 303c to exceed the original glazing's visual size by at least one-half in each relevant dimension. Adhesive means 318c are cut into strips and adhered to opposite sides of standoff/anchor 306c (front and back). Standoff/anchor 306c may then be mounted on opening frame 301c after which panel 301c may be adhered to the adhesive strip 318c facing it.

Nothing in this description is intended to preclude the preparation of this system at a location away from the job site. For instance, with dimensions of a particular job, preparers may precut the panels and the standoffs. As the adhesive means may typically be double-sided with pull-away backings, preparers may affix one side of the adhesive to both sides of a standoff 306c. At the job site, the remaining backings would be removed enabling the proper placement of the components. For additional ventilation, two or more layers of the ribbed panel material may be built up via a bonding agent, thus increasing the standoff distance from the opening. If this system is intended to be temporary,

The standoff 306c may be bonded to the frame via the “snap back” system described in FIG. 3A above. With this embodiment, a standoff separation from the glass 308c is accomplished in this manner, using both the depth of the opening's original frame 301 and the standoff created from panel material 306.

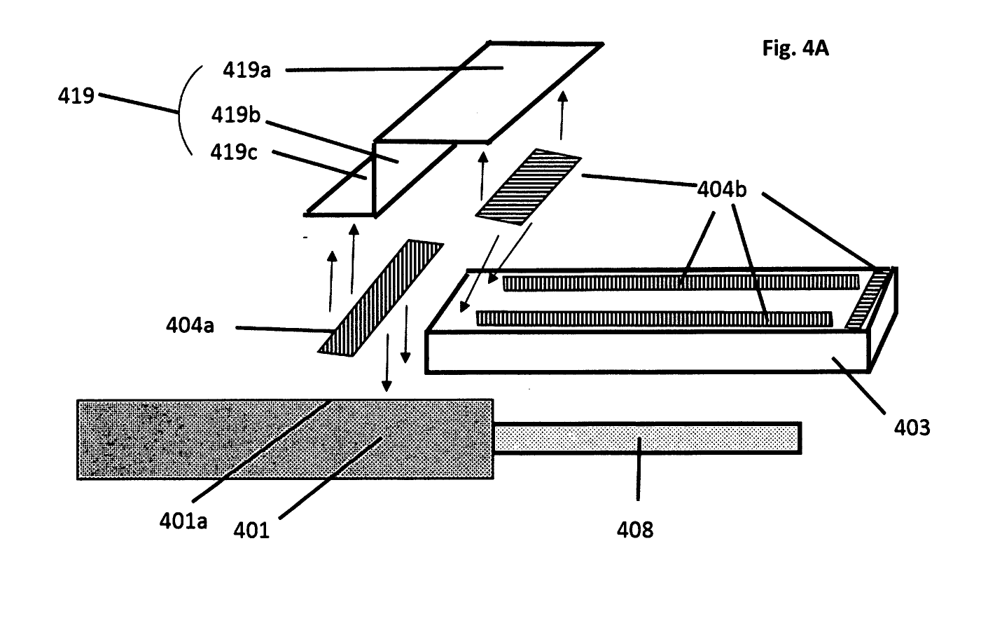

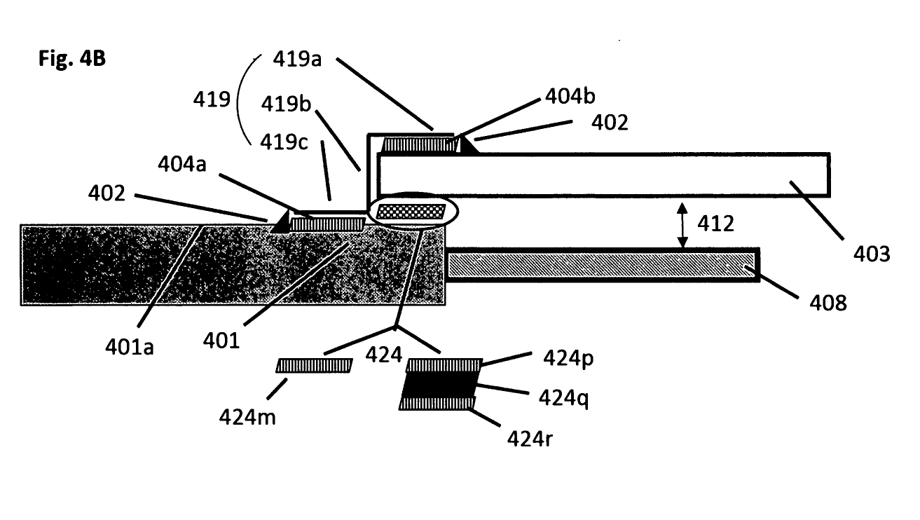

FIGS. 4A&B illustrate another embodiment to protect original pane 408 that is set within an opening 401 that provides minimal standoff depth (from pane to outside skin, door skin 401a in this case). In this embodiment a Z bar channel 419 may be utilized. Panel 403 is pre-cut to the dimensions of the visible glazing to be protected plus at least three-fourths inches in each dimension. The adhesive means 404b may be double-sided and adhered in advance to external perimeter of panel 403 and/or the underside of standoff/anchor means 419 at underside of arm 419a. Adhesive means 404a (may be the same product as 404b) may be adhered in advance to standoff anchor means 419 at underside of arm 419c. The standoff distance may be increased depending upon the width of standoff/anchor 419 center arm 419b: increasing this width would cause panel 403 to be further from original pane 408. Methodically, panel 403 may first be adhered to standoff/anchors 419 at the underside of 419a around its entire perimeter. Next, the remaining backing on 404a may be removed and the assembly comprising standoff/anchor means 419 & panel 403 would be adhered to door skin 401a after preparation of the adherence site on door skin 401a.

FIG. 4B further illustrates in a cross-sectional view how this system increases the standoff distance 412 because panel 403 is held off of the door skin via standoff/anchor means 419 because of panel 403's bonding at the underside of arm 419a. The standoff distance 412 is again determined by the length of middle iron 419b.

FIG. 4B also illustrates an alternative embodiment to increase the strength of the system. Standoff/anchor means 424 may be placed around the inside perimeter of panel 403 and make contact with the door skin 401a; this may be comprised of one or more strips double-sided adhesive means that may have a thicker core 424m to achieve standoff distance OR it may be comprised of a sandwich of components having a strong, thick material (like wood, metal, or plastic) to increase standoff distance of any thickness 424q sandwiched between one or more double-sided adhesives 424p and/or 424r enabling the additional anchoring and standoff of panel 403. As with the other embodiments, sealant 402 may be applied around the perimeter of the junction of arm 419c and skin 401a and at the junction of arm 419a and panel 403.

These last 2 embodiments may offer protection from storms using inexpensive, lightweight multiwall polycarbonate sheets in a removable (temporary) application. It is designed to replace plywood that is often used as an inexpensive (but ineffective) storm protection. Many of the qualities expressed above are retained in a non-permanent version that can be set up and removed many times as it is affixed to the building using VHB snap-back tapes. These tapes are composed of hundreds of mushroom caps that interlock to create a strong but removable attachment.

It is worth noting that different types of adhesive means may be used. “Very High Bond” (VHB) tapes are permanent. If a snap lock type of VHB tape is used, the panel will be temporary and can be removed and reapplied several times, as would be relevant if the desired protection is wind-storm related. This feature may also allow the system to comply with the fire code for egress/ingress. The multi-wall polycarbonate panel is light emitting contrary to plywood room darkening properties.

The use of decorative edge banding self-adhesive tapes on the outside edge of the panels to make the permanent installation seem almost invisible.

In an alternative embodiment, a graffiti window film can be applied to protect panels from scratching and attempts to deface the panel, and to add another layer of UV protection.

1. A glazing protection system, comprising:
a frame attached to the opening of a building structure in which is contained an original glazing;
a protective panel having dimensions slightly shorter than the dimensions of the frame and/or the underlying exposed glass;
a standoff/anchor means; and
an adhesive means containing adhesive surfaces on either side of the adhesive means used to bond the frame to the standoff/anchor means and bonding another surface of the standoff/anchor means to the protective panel.

2. The glazing protection system of claim 1, wherein the frame may part of a window or door.

3. The glazing protection system of claim 2, wherein the protective panel may be made of polycarbonate, acrylic, wood, or metal.

4. The glazing protection system of claim 3, wherein the protective panel's dimensions are less than that of the exposed glass in the range of 0.010 to 0.500 inches.

5. The glazing protection system of claim 1, wherein the standoff/anchor means may be in the configuration of flat strips of rectangular cross-section, right angled material, or box channel, any of which may be made of metal or plastic.

6. The glazing protection system of claim 5, wherein the standoff/anchor means provide a gap between the protective panel and original glazing of at least 0.050 inches.

7. The glazing protection system of claim 1, wherein the substrate of the adhesive means may be comprised of foam, rubber, plastic or any other substrate that may provide a cushioning effect.

8. The glazing protection system of claim 7, wherein the substrate of the adhesive means may be of a thickness between 0.010 and 1.500 inches.

9. The glazing protection system of claim 1, further comprising a support mullion in substantially the middle of one dimension that adds support to the protective panel against external impacts.

10. The glazing protection system of claim 1, further comprising a cushion pad may be positioned in substantially the center of the panel-glazing configuration and adhered to either or both.

11. The glazing protection system of claim 1, further comprising a cushion pad may be positioned in substantially the center of the panel-glazing configuration and adhered to either or both.

12. A glazing protection system, comprising:
a frame attached to the opening of a building structure in which is contained an original glazing;
a protective panel having dimensions slightly greater than the dimensions of the frame and/or underlying exposed glass; and
an adhesive means containing adhesive surfaces on either side of the adhesive means used to bond the frame to the protective panel.

13. The glazing protection system of claim 12, wherein the frame may part of a window or door.

14. The glazing protection system of claim 13, wherein the protective panel may be made of polycarbonate, acrylic, wood, or metal.

15. The glazing protection system of claim 14, wherein the protective panel's dimensions are greater than that of the frame or exposed glass in the range of 0.250 to 2.000 inches.

16. The glazing protection system of claim 12, wherein the substrate of the adhesive means may be comprised of foam, rubber, plastic or any other substrate that may or may not provide a cushioning effect.

17. The glazing protection system of claim 16, wherein the substrate of the adhesive means may be of a thickness between 0.010 and 1.500 inches.

18. The glazing protection system of claim 12, further comprising a support mullion in substantially the middle of one dimension that adds support to the protective panel against external impacts.

19. The glazing protection system of claim 12, further comprising a cushion pad may be positioned in substantially the center of the panel-glazing configuration and adhered to either or both.

20. A glazing protection system, comprising:
an opening of a building structure in which is contained an original glazing;
a protective panel having dimensions slightly greater than the dimensions of the frame and/or underlying exposed glass and/or structural opening;
a standoff/anchor means that is solid or channeled; and
an adhesive means containing adhesive surfaces on either side of the adhesive means used to bond the protective panel to the standoff/anchor means with another adhesive means used to bond the standoff/anchor to the building and/or frame.

21. The glazing protection system of claim 20 on which belts attached to at least 2 anchors affixed to the building are used to compress the system against the opening for additional support.

22. A glazing protection system, comprising:
a frame attached to the opening of a building structure in which is contained an original glazing;
a protective panel having dimensions slightly greater than the dimensions of the frame and/or underlying exposed glass;
a standoff/anchor means in the form of substantially a Z channel; and
an adhesive means containing adhesive surfaces on either side of the adhesive means used to bond the frame to the underside of the outer face of the Z-channel/standoff/anchor means and also bond from the underside of the innermost face of the Z-channel/standoff/anchor means to the protective panel.
